(19) United States
(12) Patent Application Publication
(10) Pub. No.: US 2025/0348359 A1
(43) Pub. Date: Nov. 13, 2025

(54) MANAGING RESOURCES OF A DOCKING STATION

(71) Applicant: Dell Products L.P., Round Rock, TX (US)

(72) Inventors: SRINIVASA RAGAVAN RAJAGOPALAN, Bangalore (IN); ANUP KESHWANI, Bangalore (IN); GOKUL THIRUCHENGODE VAJRAVEL, Bangalore (IN)

(21) Appl. No.: 18/659,115

(22) Filed: May 9, 2024

(51) Int. Cl. G06F 9/50

(52) U.S. Cl. CPC G06F 9/5027

(57) ABSTRACT

Managing resources of a docking station, including establishing a coupling between an information handling system and the docking station; providing a user identifier associated with a user of the information handling system and first parameters associated with the information handling system; identifying second parameters associated with the docking station; requesting a partition of resources of the docking station, including providing the user identifier, the first parameters, and the second identifiers; in response to the request: identifying key performance indicators (KPIs) based on the user identifier, the first parameters, and the second parameters; determining a configuration of the resources of the docking station based on the KPIs; providing the configuration; and applying the configuration to partition the resources of the docking station.

### BACKGROUND

### Field of the Disclosure

The disclosure relates generally to managing resources of a docking station.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A docking station is a peripheral device that allows a laptop or portable computer to connect to various external peripherals and accessories. It serves as a central hub, providing additional ports and functionality beyond what the laptop itself offers. Docking stations are commonly used in office environments, where users can quickly connect their laptops to a larger monitor, keyboard, mouse, and other devices. Docking stations typically include a variety of ports, such as USB, HDMI, DisplayPort, Ethernet, audio jacks, and power connectors. These ports allow users to connect external monitors, printers, external hard drives, and other peripherals without the hassle of plugging and unplugging individual cables each time.

### SUMMARY

Innovative aspects of the subject matter described in this specification may be embodied in a method of managing resources of a docking station, including establishing a coupling between an information handling system and the docking station; providing, by the information handling system and to the docking station, a user identifier associated with a user of the information handling system and first parameters associated with the information handling system; identifying, by the docking station, second parameters associated with the docking station; requesting, by the docking station and to an external computing device communicatively coupled to the docking station, a partition of resources of the docking station, including providing the user identifier, the first parameters, and the second identifiers; in response to the request: identifying, by the external computing device, key performance indicators (KPIs) based on the user identifier, the first parameters, and the second parameters; determining, by the external computing device, a configuration of the resources of the docking station based on the KPIs; providing, by the external computing device and to the docking station, the configuration; and applying, by the docking station, the configuration to partition the resources of the docking station.

Other embodiments of these aspects include corresponding systems, apparatus, and computer programs, configured to perform the actions of the methods, encoded on computer storage devices.

These and other embodiments may each optionally include one or more of the following features. For instance, storing, at the docking station, data indicating the user identifier and the first parameters. Determining the configuration of the resources further includes identifying a previously generated configuration of the resources based on the KPIs. Determining the configuration of the resources further includes generating the configuration of the resources based on the KPIs. Identifying the KPIs further includes identifying an entitlement of the resources of the docking station based on the user identifier. Identifying the KPIs further includes identifying a security risk of the resources of the docking station based on the first parameters associated with the information handling system, the resources including interfaces of the docking station. Identifying the KPIs further includes identifying a performance of peripheral devices connected to the docking station based on the first parameters associated with the information handling system and the second parameters associated with the docking station. Identifying the KPIs further includes identifying a usage of the peripheral devices based on the first parameters associated with the information handling system and the second parameters associated with the docking station. Requesting, by the docking station and to the information handling system, the user identifier and the first parameters associated with the information handling system. The first parameters include parameters associated with an operating system (OS) executing at the information handling system and applications executing at the information handling system. The second parameters include interfaces of the docking station and computing peripherals connected to the docking station.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of a computing environment.

FIG. 2 illustrates a block diagram of a computing environment for managing resources of a docking station.

FIG. 3 illustrates a swim-lane diagram for managing resources of a docking station.

FIG. 4 illustrates a method for managing resources of a docking station.

### DESCRIPTION OF PARTICULAR EMBODIMENT(S)

This disclosure discusses methods and systems for managing resources of a docking station. In short, the capability of the docking station can be extended by partitioning the resources and interfaces of the docking station. The resources of the docking station can be partitioned based on usage such that when less critical interfaces are updated, connected peripherals currently being used are not interrupted. The resources of the docking station can be partitioned based on entitlements such that a user/group can only use intended interfaces and/or peripherals. The resources of the docking station can be partitioned based on security such that access to peripherals can be limited/partitioned to only secure hosts. The resources of the docking station can be partitioned based on performance such that related connected peripherals are in the same partition to increase performance.

Specifically, this disclosure discusses a system and a method for establishing a coupling between an information handling system and the docking station; providing, by the information handling system and to the docking station, a user identifier associated with a user of the information handling system and first parameters associated with the information handling system; identifying, by the docking station, second parameters associated with the docking station; requesting, by the docking station and to an external computing device communicatively coupled to the docking station, a partition of resources of the docking station, including providing the user identifier, the first parameters, and the second identifiers; in response to the request, identifying, by the external computing device, key performance indicators (KPIs) based on the user identifier, the first parameters, and the second parameters; determining, by the external computing device, a configuration of the resources of the docking station based on the KPIs; providing, by the external computing device and to the docking station, the configuration; and applying, by the docking station, the configuration to partition the resources of the docking station.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

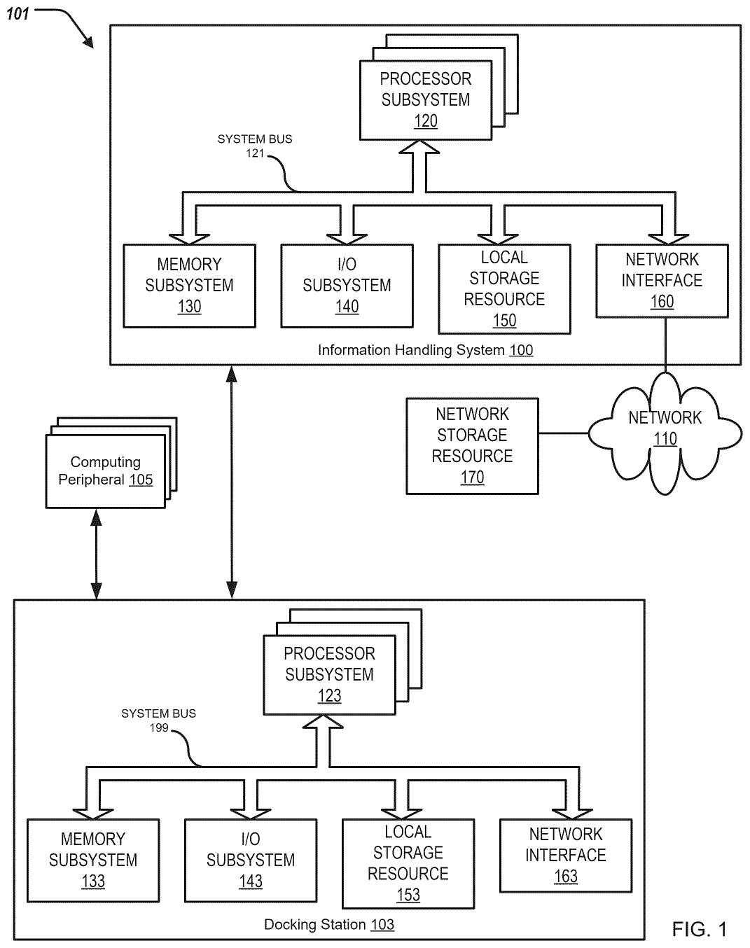

Particular embodiments are best understood by reference to FIGS. 1-4 wherein like numbers are used to indicate like and corresponding parts.

Turning now to the drawings, FIG. 1 illustrates a block diagram depicting selected elements of a computing environment 101 including an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The environment 101 can further include a docking station 103 (or a “smart” docking station). The docking station 103 can be coupled to the information handling system 101—that is, the information handling system 101 can be physically coupled to the docking station 103 as well as communicatively coupled to the docking station 103. One or more peripherals 105 can be coupled (physically and communicatively) to the docking station 103. In short, the docking station 103 facilitates connection between the information handling system 101 and the peripherals 105 acting as a central hub to stream connectively and productivity of the information handling system 101. The peripherals 105 can include external displays, keyboards, mice, wired Ethernet, backup hard drives, printers, and the like.

The docking station 103 can include a processor subsystem 123, a memory subsystem 133, an I/O subsystem 143, a local storage resource 153, a network interface 163, and a system bus 199. The processor subsystem 123, the memory subsystem 133, the I/O subsystem 143, the local storage resource 153, the network interface 163, and the system bus 199 can be similar to (similar functionality) the processor subsystem 120, the memory subsystem 130, the I/O subsystem 140, the local storage resource 150, the network interface 160, and the system bus 121 of the information handling system 100.

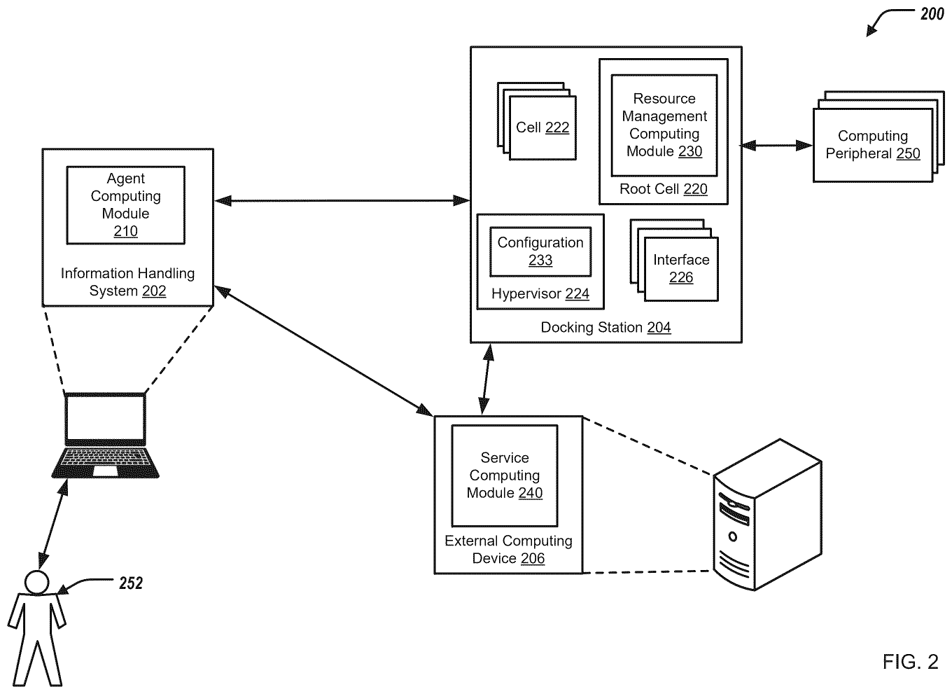

Turning to FIG. 2, FIG. 2 illustrates an environment 200 including an information handling system 202, a docking station 204, and an external computing device 206. The information handling system 202 can include an agent computing module 210. In some examples, the information handling system 202 is similar to, or includes, the information handling system 100 of FIG. 1.

The docking station 204 can include a root cell 220, cells 222, and a hypervisor 224. The root cell 220 can include a resource management computing module 230. The hypervisor 224 can include a configuration 233 that indicates the number of cells 222 and what each cell 222 contains—e.g., resources and services of the docking station 204, described further herein. In some examples, the cells 222 are equivalent to virtual machines. The root cell 220 is mandatory and marked/indicated as active. The root cell 220 can include an allocation of resources of the docking station 204 such as CPU, RAM, and the interfaces 226. The cells 222 can be marked as inactive or active depending on the configuration 233. The docking station 204 can further include interfaces 226. The interfaces 226 can include such interfaces as HDMI, BT, DP, and wireless. In some examples, the docking station 204 is similar to, or includes, the docking station 103 of FIG. 1.

The external computing device 206 can include a service computing module 240. The external computing device 206 can be a cloud-based computing device (or cloud-based server). The external computing device 206 can include one or more computing devices/computing servers.

The information handling system 202 can be in communication with the docking station 204. That is, the information handling system 202 can be physically and communicably coupled with the docking station 204. In some examples, the information handling system 202 is in communication with the docking station 204 over a stateless out-of-band (OOB) channel. The information handling system 202 can further be in communication with the external computing device 206, e.g., over a network (the Internet).

The docking station 204 can be in communication with the information handling system 202. That is, the docking station 204 can be physically and communicably coupled with the information handling system 202. The docking station 204 can further be in communication with the external computing device 206, e.g., over a network (the Internet).

The external computing device 206 can be in communication with the information handling system 202 and the docking station 204, e.g., over a network (the Internet).

One or more computing peripherals 250 (or peripheral devices 250, or devices 250) can be coupled to the docking station 204. The computing peripherals 250 can be similar to, or include, the computing peripherals 105 of FIG. 1. For example, the computing peripherals 250 can include a monitor, an eGPU, or a webcam.

In short, the capability of the docking station 204 can be extended by partitioning the resources and interfaces 226 of the docking station 204. The resources of the docking station 204 can be partitioned based on usage such that when less critical interfaces are updated, connected peripherals currently being used are not interrupted. The resources of the docking station 204 can be partitioned based on entitlements such that a user/group can only use intended interfaces and/or peripherals. The resources of the docking station 204 can be partitioned based on security such that access to peripherals can be limited/partitioned to only secure hosts. The resources of the docking station 204 can be partitioned based on performance such that related connected peripherals are in the same partition to increase performance.

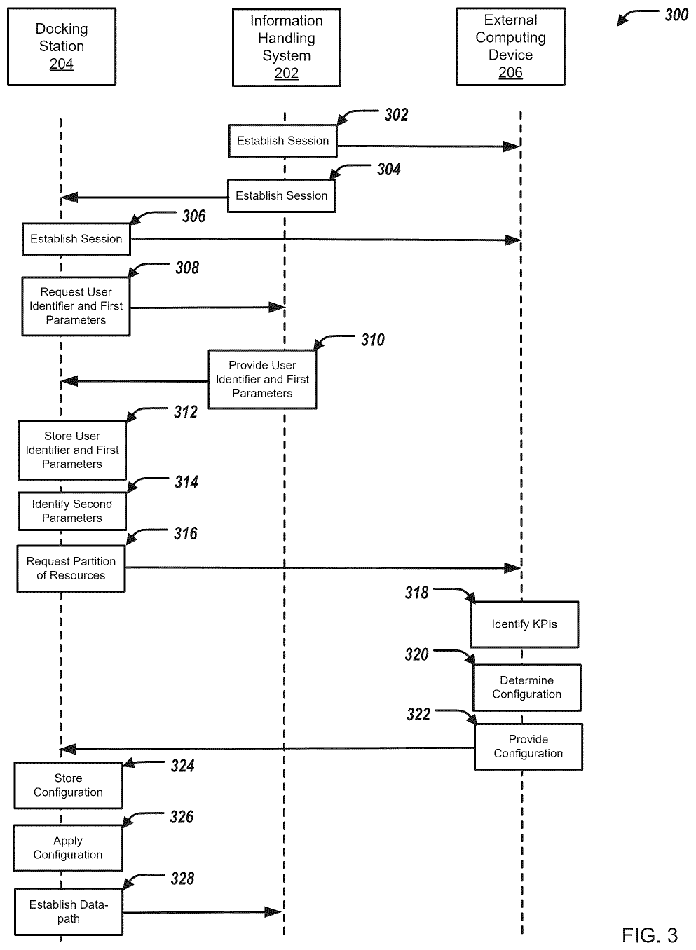

FIG. 3 illustrates a swim-lane diagram depicting selected elements of an embodiment of a method 300 for managing resources of a docking station. The method 300 may be performed by the information handling system 100, the docking station 103, the information handling system 202, the docking station 204, and/or the external computing device 206, and with reference to FIGS. 1-2. It is noted that certain operations described in method 300 may be optional or may be rearranged in different embodiments.

The information handling system 202 establishes a connection with the external computing device 206, at 302. Specifically, the agent computing module 210 of the information handling system 202 establishes the connection (communication connection) with the external computing device 206.

The information handling system 202 establishes a connection with the docking station 204, at 304. Specifically, the agent computing module 210 of the information handling system 202 establishes a connection (communication connection) with the docking station 204. In other words, a coupling is established between the information handling system 202 and the docking station 204.

The docking station 204 establishes a connection with the external computing device 206, at 306. Specifically, the resource management computing module 230 establishes a connection with the external computing device 206.

The docking station 204, and in particular, the resource management computing module 230, requests, from the information handling system 202, a user identifier and first parameters associated with the information handling system 202, at 308. For example, a user 252 of the information handling system 202 can provide a user identifier or user credentials (e.g., username and password) to the information handling system 202 via an input device (such as a keyboard) to gain access to the information handling system 202.

The information handling system 202, and in particular, the agent computing module 210, can provide, to the docking station 204, the user identifier associated with the user 252 of the information handling system 202 and the first parameters associated with the information handling system 202, at 310. In some examples, the first parameters can include data indicating an operating system (OS) associated with the information handling system 202 (executing at the information handling system 202), applications executing at the information handling system 202 (currently, or previously), and other similar parameters of the information handling system 202.

The docking station 204, and in particular, the resource management computing module 230, can store the data indicating the user identifier and the first parameters, at 312.

The docking station 204, and in particular, the resource management computing module 230, can identify second parameters associated with the docking station, at 314. In some examples, the second parameters can include details regarding the interfaces 226 (e.g., which ones are active/inactive and which ones are being utilized/non-utilized); and the computing peripherals 250 (e.g., which ones are active/inactive and which ones are being utilized/non-utilized).

The docking station 204, and in particular, the resource management computing module 230, requests, to the external computing device 206, a partition of the resources of the docking station 204, at 316. For example, the resources can include the cells 222, or the underlaying components such as CPU, memory, etc. In some examples, the docking station 204 can provide the current configuration 233 of the docking station 204 to the external computing device 206 (current partition of the cells 222 of the docking station 204). In some examples, the docking station 204 can provide the user identifier, the first parameters, and the second parameters to the external computing device 206.

The external computing device 206, and in particular, the service computing module 240, in response to the request, identifies key performance indicators (KPIs), at 318. Specifically, the external computing device 206 can identify the KPIs based on the user identifier, the first parameters, and the second parameters. In other words, the external computing device 206 can identify certain KPIs-such as performance, security, entitlements, and usage-based on the user identifier, the first parameters, and/or the second parameters.

In some examples, the external computing device 206 identifies the KPIs by identifying an entitlement of the resources of the docking station 204 based on the user identifier. Specifically, the external computing device 206 can identify entitlements of the resources of the docking station 204 that are associated with the user identifier (e.g., such associations stored in memory of the external computing device 206). For example, the entitlements associated with the user identifier can include which interfaces 226 the user 252 is allowed to access. For example, the entitlements associated with the user identifier can indicate that USB and HDMI interfaces 226 are allowed, and BT and DP interfaces 226 are blocked. For example, the entitlements associated with the user identifier can include which computing peripherals 250 the user 252 is allowed to access.

In some examples, the external computing device 206 identifies the KPIs by identifying a security risk of the resources of the docking station 204 based on the first parameters associated with the information handling system 202. Specifically, the external computing device 206 can limit access to the interfaces 226 and the computing peripherals 250 based on the first parameters associated with the information handling system 202. For example, the first parameters of the information handling system 202 can indicate a security posture of the information handling system 202. To that end, the external computing device 206 can limit access to the interfaces 226 and the computing peripherals 250 based on the security posture of the information handling system 202. For example, based on the first parameters of the information handling system 202 indicating a “bad” security posture of the information handling system 202 (e.g., the information handling system 202 is susceptible to a security breach), the external computing device 206 can limit access to interfaces 226 that are “high-risk”-USB-C, BT, WiFi.

In some examples, the external computing device 206 identifies the KPIs by identifying a performance of the peripheral devices 250 connected to the docking station 204. Specifically, the external computing device 206 can group the interfaces 226 and the computing peripherals 250 based on the first parameters associated with the information handling system 202 and the second parameters associated with the docking station 204. For example, the first parameters can indicate desired computing peripherals 250 to be utilized by the information handling system 202, and the second parameters can indicate available interfaces 226 of the docking station 204. To that end, the external computing device 206 can identify the performance of the peripheral devices 250 and resources of the docking station 204 to maximize performance of the same (and/or maximize efficiency of the same).

In some examples, the external computing device 206 identifies the KPIs by identifying a usage of the peripheral devices 250 connected to the docking station 204. Specifically, the external computing device 206 can group the interfaces 226 and the computing peripherals 250 based on the first parameters associated with the information handling system 202 and the second parameters associated with the docking station 204. For example, the first parameters can indicate a usage of the computing peripherals 250 by the information handling system 202, and the second parameters can indicate a usage of the interfaces 226 of the docking station 204.

The external computing device 206, in response to the request, can determine a configuration of the resources of the docking station 204, at 320. Specifically, the external computing device 206, and in particular, the service computing module 240, can determine the configuration of the resources of the docking station 204 based on the KPIs. That is, the external computing device 206 can determine the allocation/configuration of the resources of the docking station 204, such as the cells 222 and the interfaces 226, based on the KPIs. In other words, the external computing device 206, based on the KPIs, can determine a configuration that partitions the resources of the docking station 204 to include active cells 222 and active interfaces 226 and inactive cells 222 and inactive interfaces 226. The external computing device 206 can partition the cells 222 and the interfaces 226 into separate groupings/partitions based on the KPIs.

In some examples, the KPIs indicate an entitlement of the resources of the docking station (based on the user identifier). Specifically, the external computing device 206 can, based on the identified entitlements (at 318), partition the resources of the docking station 204. That is, the external computing device 206 partitions the cells 222 and the interfaces 226 of the docking station 204 based on the identified entitlements. That is, for particular entitlements associated with the user identifier (of the user 252), the external computing device 206 can determine a configuration to limit, restrict, or allow access to the cells 222 and the interfaces 226. In other words, the external computing device 206, based on the identified entitlements, can determine a configuration that partitions the resources of the docking station 204 to include active cells 222 and active interfaces 226 and inactive cells 222 and inactive interfaces 226. The external computing device 206 can partition the cells 222 and the interfaces 226 into separate groupings/partitions based on the entitlement of the resources. For example, the external computing device 206 can, based on the identified entitlements, determine a configuration that allows access to the USB and HDMI interfaces 226 and blocks the BT and DP interfaces 226. That is, the external computing device 206 can, based on the identified entitlements, partition/group the USB and HDMI interfaces 226 into a first partition (e.g., group into the same cell 222 that is active) and partition/group the BT and DP interfaces 226 into a second partition (e.g., group into the same cell 222 that is inactive).

In some examples, the KPIs indicate a security risk of the resources of the docking station 204 (based on the first parameters associated with the information handling system 202). Specifically, the external computing device 206 can, based on the identified security risk of the information handling system 202 (at 318), partition the resources of the docking station 204. That is, the external computing device 206 partitions the cells 222 and the interfaces 226 of the docking station 204 based on the identified security risk/security posture of the information handling system 202. That is, for the identified security posture associated with the first parameters associated with the information handling system 202, the external computing device 206 can determine a configuration to limit, restrict, or allow access to the cells 222 and the interfaces 226. In other words, the external computing device 206, based on the security risk/security posture of the information handling system 202, can determine a configuration that partitions the resources of the docking station 204 to include active cells 222 and active interfaces 226 and inactive cells 222 and inactive interfaces 226. For example, the external computing device 206 can, based on the identified security risk/security posture, determine a configuration that limits access to interfaces 226 that are “high-risk”-USB-C, BT, WiFi. For example, the external computing device 206 can, based on a “bad” security risk/security posture (e.g., the information handling system 202 is susceptible to a security breach), determine a configuration that limits access to interfaces 226 that are “high-risk”-USB-C, BT, WiFi. That is, the external computing device 206 can, based on the identified security risk/security posture, partition/group the USB-C, BT, and WiFi interfaces 226 into a first partition (e.g., group into the same cell 222 that is inactive) and partition/group the remaining interfaces 226 into a second partition (e.g., group into the same cell 222 that is active).

In some examples, the KPIs indicate a performance of the peripheral devices 250 connected to the docking station 204 (based on the first parameters associated with the information handling system 202 and the second parameters associated with the docking station 204). Specifically, the external computing device 206 can, based on the identified performance of the peripheral devices 250 (at 318), partition the resources of the docking station 204. That is, the external computing device 206 partitions the cells 222 and the interfaces 226 of the docking station 204 based on the identified performance of the peripheral devices 250. That is, for the identified performance of the peripheral devices 250 associated with the first parameters associated with the information handling system 202 and the second parameters associated with the docking station 204, the external computing device 206 can determine a configuration to limit, restrict, or allow access to the cells 222 and the interfaces 226. In other words, the external computing device 206, based on the performance of the peripheral devices 250, can determine a configuration that partitions the resources of the docking station 204 to include active cells 222 and active interfaces 226 and inactive cells 222 and inactive interfaces 226. For example, the external computing device 206 can, based on the identified performance of the peripheral devices 250, determine a configuration that groups connected peripheral devices 250 that are related into a same partition/grouping (the same active cell 222) to increase performance of the connected peripheral devices 250 (maximizes performance, maximizes efficiency, or both, of the connected peripheral devices). For example, the external computing device 206 can, based on identified performance of the peripheral devices 250, group a high-resolution monitor peripheral device 250 (and the associated interface 226 that the high-resolution monitor peripheral device 250 is coupled to) and an eGPU (of the docking station 204) into the same partition/grouping (within an active cell 222) to increase performance of the high-resolution monitor peripheral device 250 and the eGPU (such that the same are accessing/utilizing the same CPU, or portion of CPU, and the same memory, or portion of memory).

In some examples, the KPIs indicate a usage of the peripheral devices 250 connected to the docking station 204 (based on the first parameters associated with the information handling system 202 and the second parameters associated with the docking station 204). Specifically, the external computing device 206 can, based on the identified usage of the peripheral devices 250 (at 318), partition the resources of the docking station 204. That is, the external computing device 206 partitions the cells 222 and the interfaces 226 of the docking station 204 based on the identified usage of the peripheral devices 250. That is, for the identified usage of the peripheral devices 250 associated with the first parameters associated with the information handling system 202 and the second parameters associated with the docking station 204, the external computing device 206 can determine a configuration to limit, restrict, or allow access to the cells 222 and the interfaces 226. In other words, the external computing device 206, based on the usage of the peripheral devices 250, can determine a configuration that partitions the resources of the docking station 204 to include active cells 222 and active interfaces 226 and inactive cells 222 and inactive interfaces 226. For example, the external computing device 206 can, based on the identified usage of the peripheral devices 250, determine a configuration that groups commonly used or currently used peripheral devices 250 and interfaces 226 into a same partition/grouping (the same active cell 222) and not commonly used or not currently used peripheral devices 250 and interfaces 226 into a same partition/grouping (the same inactive cell 222). This can afford that when there is an update (firmware update) to particular peripheral devices 250/interfaces 226 of the inactive cell 222, the update can be performed (access to these particular peripheral devices 250/interfaces 226 can be interrupted during such update) without affecting the performance of the peripheral devices 250/interfaces 226 of the active cell 222.

In some examples, the external computing device 206, in response to the request, can determine a configuration of the resources of the docking station 204 (at 320) by identifying a previously generated configuration of the resources based on the KPIs. That is, the external computing device 206 can previously generate the configuration based on the KPIs at an earlier time, and access the configuration (stored at a storage device) based on the same (or similar) KPIs that are currently provided.

In some examples, the external computing device 206, in response to the request, can determine a configuration of the resources of the docking station 204 (at 320) by generating a new (or updated) configuration of the resources based on the KPIs.

The external computing device 206, and in particular, the service computing module 240, provides, to the docking station 204, the configuration, at 322.

The docking station 204, and in particular, the resource management computing module 230, stores the configuration, at 324. In particular, the configuration 233 is updated based on the newly received configuration.

The docking station 204, and in particular, the resource management computing module 230, applies the configuration, at 326. In particular, the docking station 204 applies the configuration to partition the resources of the docking station 204. For example, the docking station 204 applies the configuration to partition the cells 222 as inactive or active based on the resources contained by each of the cells 222.

The docking station 204, and in particular, the resource management computing module 230, can establish a data path, at 328. In particular, the docking station 204, after applying the configuration of the resources, establishes a data path (or re-establishes the data path) between the docking station 204 and the information handling system 202.

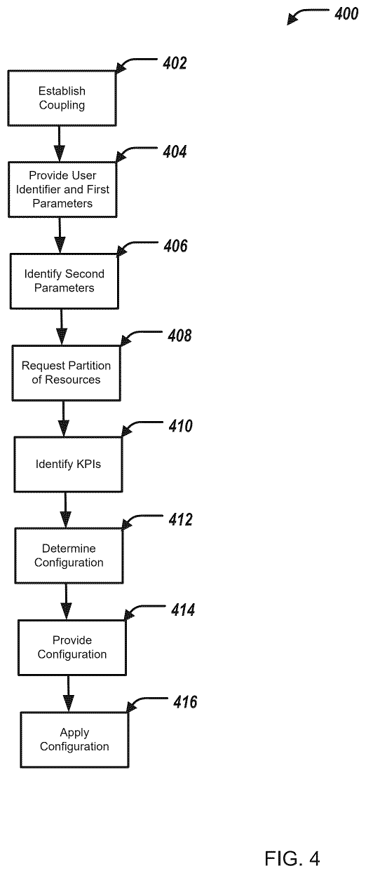

FIG. 4 illustrates a flowchart depicting selected elements of an embodiment of a method 400 for managing resources of a docking station. The method 400 may be performed by the information handling system 100, the docking station 103, the information handling system 202, the docking station 204, and/or the external computing device 206, and with reference to FIGS. 1-2. It is noted that certain operations described in method 400 may be optional or may be rearranged in different embodiments.

The information handling system 202 establishes a connection with the external computing device 206, at 402. The information handling system 202 provides, to the docking station 204, the user identifier associated with the user 252 of the information handling system 202 and the first parameters associated with the information handling system 202, at 404. The docking station 204 identifies second parameters associated with the docking station, at 406. The docking station 204 requests, to the external computing device 206, a partition of the resources of the docking station 204, at 408. The external computing device 206, in response to the request, identifies key performance indicators (KPIs), at 410. The external computing device 206, in response to the request, can determine a configuration of the resources of the docking station 204, at 412. The external computing device 206 provides, to the docking station 204, the configuration, at 414. The docking station 204 applies the configuration, at 326.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of managing resources of a docking station, including:
establishing a coupling between an information handling system and the docking station;
providing, by the information handling system and to the docking station, a user identifier associated with a user of the information handling system and first parameters associated with the information handling system;
identifying, by the docking station, second parameters associated with the docking station;
requesting, by the docking station and to an external computing device communicatively coupled to the docking station, a partition of resources of the docking station, including providing the user identifier, the first parameters, and the second identifiers;
in response to the request:
identifying, by the external computing device, key performance indicators (KPIs) based on the user identifier, the first parameters, and the second parameters;
determining, by the external computing device, a configuration of the resources of the docking station based on the KPIs;
providing, by the external computing device and to the docking station, the configuration; and
applying, by the docking station, the configuration to partition the resources of the docking station.

2. The computer-implemented method of claim 1, further including:
storing, at the docking station, data indicating the user identifier and the first parameters.

3. The computer-implemented method of claim 1, wherein determining the configuration of the resources further includes identifying a previously generated configuration of the resources based on the KPIs.

4. The computer-implemented method of claim 1, wherein determining the configuration of the resources further includes generating the configuration of the resources based on the KPIs.

5. The computer-implemented method of claim 1, wherein identifying the KPIs further includes identifying an entitlement of the resources of the docking station based on the user identifier.

6. The computer-implemented method of claim 1, wherein identifying the KPIs further includes identifying a security risk of the resources of the docking station based on the first parameters associated with the information handling system, the resources including interfaces of the docking station.

7. The computer-implemented method of claim 1, wherein identifying the KPIs further includes identifying a performance of peripheral devices connected to the docking station based on the first parameters associated with the information handling system and the second parameters associated with the docking station.

8. The computer-implemented method of claim 1, wherein identifying the KPIs further includes identifying a usage of the peripheral devices based on the first parameters associated with the information handling system and the second parameters associated with the docking station.

9. The computer-implemented method of claim 1, further including:
requesting, by the docking station and to the information handling system, the user identifier and the first parameters associated with the information handling system.

10. The computer-implemented method of claim 1, wherein the first parameters include parameters associated with an operating system (OS) executing at the information handling system and applications executing at the information handling system.

11. The computer-implemented method of claim 1, wherein the second parameters include interfaces of the docking station and computing peripherals connected to the docking station.

12. A computing environment, including:
an information handling system comprising a processor having access to memory media storing instructions executable by the processor to perform operations;
an external computing device in communication with a docking station and the information handling system, the external computing device comprising a processor having access to memory media storing instructions executable by the processor to perform operations;
a plurality of peripheral devices;
the docking station connected to the plurality of peripheral devices and the information handling system, the docking station comprising a processor having access to memory media storing instructions executable by the processor to perform operations, comprising:
receiving, from the information handling system, a user identifier associated with a user of the information handling system and first parameters associated with the information handling system;
identifying second parameters associated with the docking station;
requesting, to an external computing device communicatively coupled to the docking station, a partition of resources of the docking station, including providing the user identifier, the first parameters, and the second identifiers;
wherein the external computing device is configured to perform operations:
identifying key performance indicators (KPIs) based on the user identifier, the first parameters, and the second parameters;
determining a configuration of the resources of the docking station based on the KPIs;
providing, to the docking station, the configuration; and
wherein the docking station is further configured to perform operations:
applying the configuration to partition the resources of the docking station.

13. The computing environment of claim 12, wherein the docking station is configured to perform operations:
storing data indicating the user identifier and the first parameters.

14. The computing environment of claim 12, wherein determining the configuration of the resources further includes identifying a previously generated configuration of the resources based on the KPIs.

15. The computing environment of claim 12, wherein determining the configuration of the resources further includes generating the configuration of the resources based on the KPIs.

16. The computing environment of claim 12, wherein identifying the KPIs further includes identifying an entitlement of the resources of the docking station based on the user identifier.

17. The computing environment of claim 12, wherein identifying the KPIs further includes identifying a security risk of the resources of the docking station based on the first parameters associated with the information handling system, the resources including interfaces of the docking station.

18. The computing environment of claim 12, wherein identifying the KPIs further includes identifying a performance of peripheral devices connected to the docking station based on the first parameters associated with the information handling system and the second parameters associated with the docking station.

19. The computing environment of claim 12, wherein identifying the KPIs further includes identifying a usage of the peripheral devices based on the first parameters associated with the information handling system and the second parameters associated with the docking station.

20. A non-transitory computer-readable medium storing software comprising instructions executable by one or more computers which, upon such execution, cause the one or more computers to perform operations comprising:
establishing a coupling between an information handling system and the docking station;
providing, by the information handling system and to the docking station, a user identifier associated with a user of the information handling system and first parameters associated with the information handling system;
identifying, by the docking station, second parameters associated with the docking station;
requesting, by the docking station and to an external computing device communicatively coupled to the docking station, a partition of resources of the docking station, including providing the user identifier, the first parameters, and the second identifiers;
in response to the request:
identifying, by the external computing device, key performance indicators (KPIs) based on the user identifier, the first parameters, and the second parameters;
determining, by the external computing device, a configuration of the resources of the docking station based on the KPIs;
providing, by the external computing device and to the docking station, the configuration; and
applying, by the docking station, the configuration to partition the resources of the docking station.
